(19) United States
(12) Patent Application Publication
(10) Pub. No.: US 2026/0251999 A1
(43) Pub. Date: Aug. 27, 2026

(54) IMAGE FORMING APPARATUS THAT FORMS IMAGE ON SHEET USING ROTARY DEVELOPING SCHEME

(71) Applicant: CANON KABUSHIKI KAISHA, Tokyo (JP)

(72) Inventors: Takanori Mitani, Kanagawa (JP); Shinsuke Kobayashi, Kanagawa (JP); Hikaru Osada, Kanagawa (JP); Isamu Takeda, Tokyo (JP); Akisato Sakaki, Kanagawa (JP)

(21) Appl. No.: 19/541,855

(22) Filed: Feb. 17, 2026

(30) Foreign Application Priority Data
Feb. 26, 2025 (JP) 2025-029371

(51) Int. Cl. G03G 15/08; G03G 15/00; G03G 15/01

(52) U.S. Cl. CPC G03G 15/0877; G03G 15/0121; G03G 15/0173; G03G 15/0862; G03G 15/5012; G03G 2215/0177

(57) ABSTRACT

An image forming apparatus includes a rotary to which a toner cartridge is detachably attached. The rotary includes a developing roller and a container configured to hold toner supplied from the toner cartridge. The rotary is switchable to a replenishment posture for transferring toner to the container. A processor controls the rotation of the rotary to execute a replenishment mode. The processor monitors a remaining toner amount in the container. If the remaining toner amount is less than a threshold, the processor maintains the rotary in the replenishment posture for a second amount of time. If the remaining toner amount is greater than the threshold, the rotary is maintained in the replenishment posture for a first amount of time. The processor is configured such that the second amount of time is longer than the first amount of time.

### BACKGROUND

### Field of the Technology

The present disclosure relates to an image forming apparatus that forms an image on a sheet using a rotary developing scheme.

### Description of the Related Art

An image forming apparatus described in Japanese Patent Laid-Open No. 2009-008794 suspends a monochrome print job and performs toner replenishment in a case where black toner in a developing chamber becomes less than or equal to a predetermined amount after the monochrome print job has started.

According to Japanese Patent Laid-Open No. 2009-008794, the replenishment operation is not changed in accordance with the remaining amount of toner in the developing chamber. Thus, the replenishment amount is not adjusted in accordance with the remaining amount of toner in the developing chamber.

### SUMMARY

The disclosure provides an image forming apparatus comprising a rotary to and from which a toner cartridge containing toner is attachable and detachable, the rotary including a developing roller and a containing unit that contains a toner supplied from the toner cartridge; and a processor configured to control rotation of the rotary. The rotary is switchable to a replenishment posture in which the containing unit is replenished with the toner from the toner cartridge. The processor executes a replenishment mode in which the rotary is rotated to be in the replenishment posture. A state of the containing unit in a case where a remaining toner amount of the containing unit is greater than a first threshold is a first state. A state of the containing unit in a case where the remaining toner amount of the containing unit is less than the first threshold is a second state. An amount of time that the rotary is in the replenishment posture in the replenishment mode executed in a case where the containing unit is in the first state is a first amount of time. An amount of time that the rotary is in the replenishment posture in the replenishment mode executed in a case where the containing unit is in the second state is a second amount of time. The processor executes the replenishment mode in such a manner that the second amount of time is longer than the first amount of time.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram for describing an image forming apparatus.

FIGS. 2A and 2B are diagrams illustrating a development posture and a standby posture.

FIGS. 3A and 3B are diagrams illustrating a development posture and a replenishment posture.

FIG. 4 is a diagram for describing a developing assembly.

FIG. 5 is a diagram for describing a controller.

FIG. 6 is a diagram for describing a predetermined amount.

FIG. 7 is a diagram for describing a method for determining the replenishment level.

FIG. 8 is a flowchart illustrating a control method.

FIG. 9 is a flowchart illustrating a control method.

FIGS. 10A and 10B are diagrams for describing predetermined amounts.

FIG. 11 is a diagram for describing a method for determining the replenishment level.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. First Embodiment Example

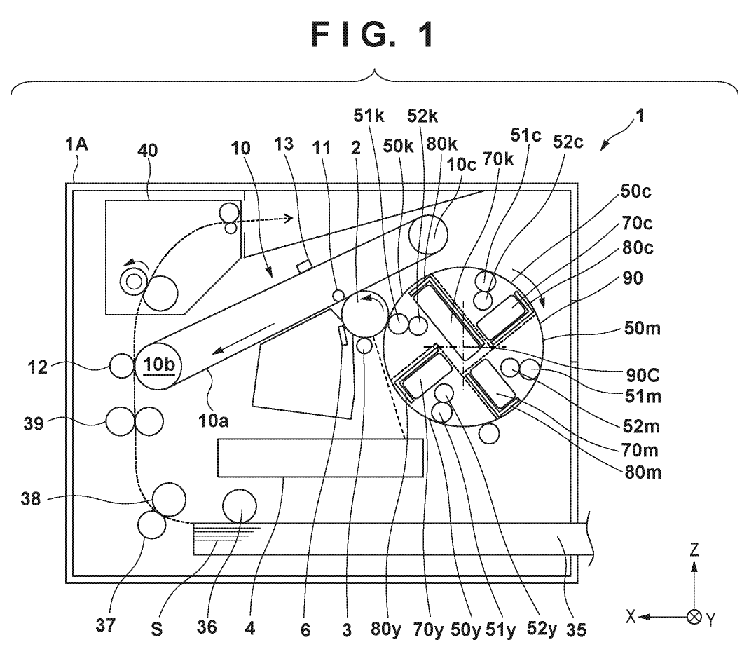

As illustrated in FIG. 1, an image forming apparatus 1 is a printer that uses a rotary developing scheme. In the following diagrams, the image forming apparatus 1 is assumed to be placed parallel with the horizontal plane. The X direction and the Y direction are both parallel with the horizontal plane. The Z direction is parallel with the vertical direction. Note that the Y direction is parallel with a rotation axis 90C of a rotary main body 90. The X direction, the Y direction, and the Z direction are perpendicular to one another.

### 1-1. Image Forming Apparatus

The image forming apparatus 1 is a laser beam printer that forms an image on a sheet S via electro-photography. The image forming apparatus 1 includes four developing units 50y, 50m, 50c, 50k of different colors. The four developing units 50y, 50m, 50c, 50k are held in the rotary main body 90. In the present specification, ymck are abbreviations for yellow, magenta, cyan, and black, which are the colors of the toner. When describing an item in common for ymck, the characters ymck are omitted from the reference signs. Examples of the sheet S, which is a printing material (printing medium), include paper such as regular paper and thick paper, plastic film, cloth, coated paper and similar sheet material obtained by surface treatment, sheet material with a special shape such as envelopes and index paper, and the like.

The image forming apparatus 1 includes an image forming apparatus main body (hereinafter referred to as an apparatus main body 1A) and toner cartridges 70y, 70m, 70c, 70k, which are toner containers that can be attached to and detached from the apparatus main body 1A. The apparatus main body 1A corresponds to the part of the image forming apparatus 1 excluding the toner cartridges 70y, 70m, 70c, 70k.

The apparatus main body 1A includes an electrophotographic photosensitive body (hereinafter referred to as a photosensitive drum 2) with a drum shape (cylindrical shape) as the image carrier for carrying the electrostatic latent image. Around the photosensitive drum 2, a charging roller 3, an exposure apparatus (scanner 4), and a cleaning unit 6 are arranged.

The charging roller 3 is an example of a charging unit that uniformly charges the surface of the photosensitive drum 2. The scanner 4 is an example of an exposing unit that emits laser light in accordance with image information at the photosensitive drum 2 and forms an electrostatic image. The cleaning unit 6 is an example of a cleaning unit that removes toner remaining on the surface of the photosensitive drum 2.

The rotary main body 90 supplies toner to the photosensitive drum 2 to develop the electrostatic latent image and form a toner image. A primary transfer roller 11 transfers the toner image from the photosensitive drum 2 to an intermediate transfer unit 10 (primary transfer).

The intermediate transfer unit 10 includes an intermediate transfer belt 10a, a driving roller 10b, a tension roller 10c, a cleaning apparatus 13, and the primary transfer roller 11. The intermediate transfer belt 10a is an example of an intermediate transfer body that carries an image transferred from the photosensitive drum 2, conveys the image, and transfers the image to the sheet S. The intermediate transfer belt 10a is installed at tension around the driving roller 10b and the tension roller 10c. The driving roller 10b is a drive unit that rotationally drives the intermediate transfer belt 10a.

Also, the apparatus main body 1A includes a sheet containing unit 35, a pickup roller 36, a feed roller 38, a separation roller 37, a conveyance roller pair 39, a secondary transfer roller 12, a fixing apparatus 40, and the intermediate transfer unit 10. The sheet containing unit 35 can contain a plurality of sheets S. The pickup roller 36 is an example of a supplying unit that supplies the sheet S from the sheet containing unit 35 to a conveying path. The feed roller 38 and the separation roller 37 are an example of a separation and conveyance unit that conveys the plurality of sheets S while separating them one sheet S at a time. The secondary transfer roller 12 is an example of a transfer unit that transfers an image (toner image) from the intermediate transfer belt 10a to the sheet S.

The fixing apparatus 40 supplies heat and pressure to the toner image and the sheet S. This fixes the toner image onto the sheet S. Thereafter, the sheet S is discharged outside of the image forming apparatus 1.

### 1-2. Rotary Main Body

The rotary main body 90 is a rotary body that rotates. The rotary main body 90 includes trays 80y, 80m, 80c, 80k. The toner cartridges 70y, 70m, 70c, 70k are detachably installed in the trays 80y, 80m, 80c, 80k, respectively. The trays 80y, 80m, 80c, 80k are each support members that support the toner cartridges 70y, 70m, 70c, 70k, respectively.

The developing units 50y, 50m, 50c, 50k are supplied with yellow toner, magenta toner, cyan toner, and black toner from the toner cartridges 70y, 70m, 70c, 70k, respectively. The developing units 50y, 50m, 50c, 50k each form a toner image using the yellow toner, magenta toner, cyan toner, and black toner, respectively.

The developing units 50y, 50m, 50c, 50k each include a developing roller 51y, 51m, 51c, 51k and a supplying roller 52y, 52m, 52c, 52k, respectively. The supplying rollers 52y, 52m, 52c, 52k are each supply units that supply the toner contained in the developing units 50y, 50m, 50c, 50k to the developing rollers 51y, 51m, 51c, 51k, respectively. The developing rollers 51y, 51m, 51c, 51k are each development agent carriers that carry the toner, rotate, and supply the toner to the photosensitive drum 2.

### 1-2. Rotational Position of Rotary Main Body

### 1-2-1. Development Posture

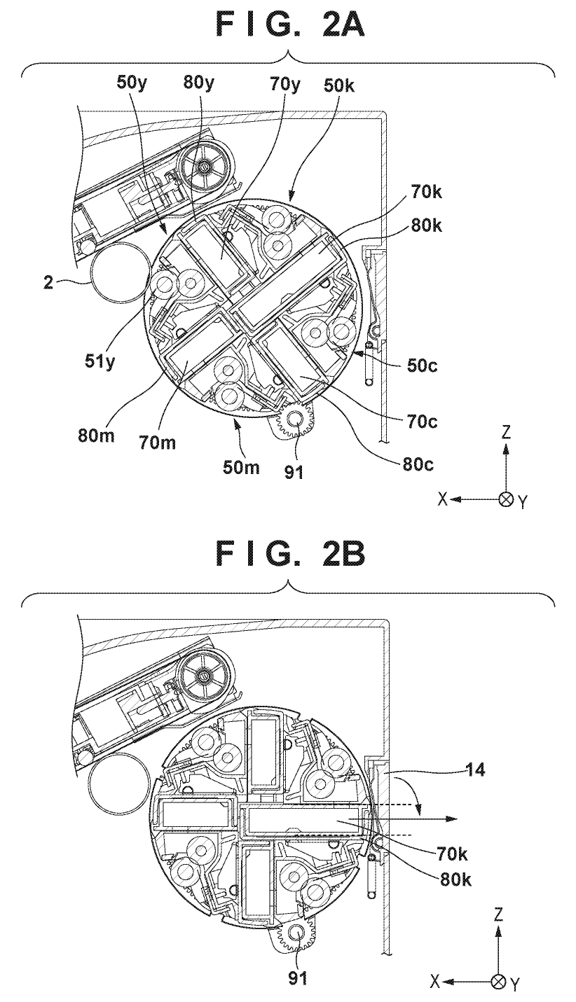

FIG. 2A illustrates the development posture (yellow development posture) of the rotary main body 90. When the rotary main body 90 rotates, one developing unit 50 from among the plurality of developing units 50y, 50m, 50c, 50k is made to face the photosensitive drum 2. In this example, the yellow developing unit 50y is facing the photosensitive drum 2. In other words, the yellow developing unit 50y is arranged at the development position. When the rotary main body 90 rotates approximately 90 degrees in the clockwise direction, the magenta developing unit 50m is arranged at the development position (magenta development posture). When the rotary main body 90 further rotates approximately 90 degrees in the clockwise direction, the cyan developing unit 50c is arranged at the development position (cyan development posture). When the rotary main body 90 further rotates approximately 90 degrees in the clockwise direction, the black developing unit 50k is arranged at the development position (black development posture).

### 1-2-2. Replacement Posture

FIG. 2B illustrates the replacement posture (black replacement posture). The toner cartridges 70y to 70k are each held in the trays 80y to 80k and can be attached to and detached from the trays 80y to 80k, respectively. The trays 80y to 80k are supported in the rotary main body 90 in a manner that allows them to slide relative to the rotary main body 90. Thus, the toner cartridges 70y to 70k slide together with the trays 80y to 80k, respectively. According to FIG. 2B, the black toner cartridge 70k is arranged at the replacement position. The outer shell of the apparatus main body 1A includes a cover 14 that can open and close. When the cover 14 is open, the tray 80k and the toner cartridge 70k positioned at the replacement position may slide in the -X direction. In this manner, the toner cartridge 70k can be exposed to the outside of the image forming apparatus 1, and the user can replace the toner cartridge 70k.

When the rotary main body 90 rotates approximately 90 degrees in the clockwise direction, the yellow toner cartridge 70y is arranged at the replacement position (yellow replacement posture). When the rotary main body 90 further rotates approximately 90 degrees in the clockwise direction, the magenta toner cartridge 70m is arranged at the replacement position (magenta replacement posture). When the rotary main body 90 further rotates approximately 90 degrees in the clockwise direction, the cyan toner cartridge 70c is arranged at the replacement position (cyan replacement posture).

Note that in a case where the rotary main body 90 is in the replacement posture, the rotary main body 90 may be separated from the photosensitive drum 2 by a swing shaft 91 swinging the rotary main body 90. When replacement of the toner cartridge 70 is complete, the rotary main body 90 may be brought into contact with the photosensitive drum 2 by the swing shaft 91 swinging the rotary main body 90. In other words, in a case where the rotary main body 90 is in the development posture, the rotary main body 90 comes into contact with the photosensitive drum 2.

### 1-2-3. Standby Posture

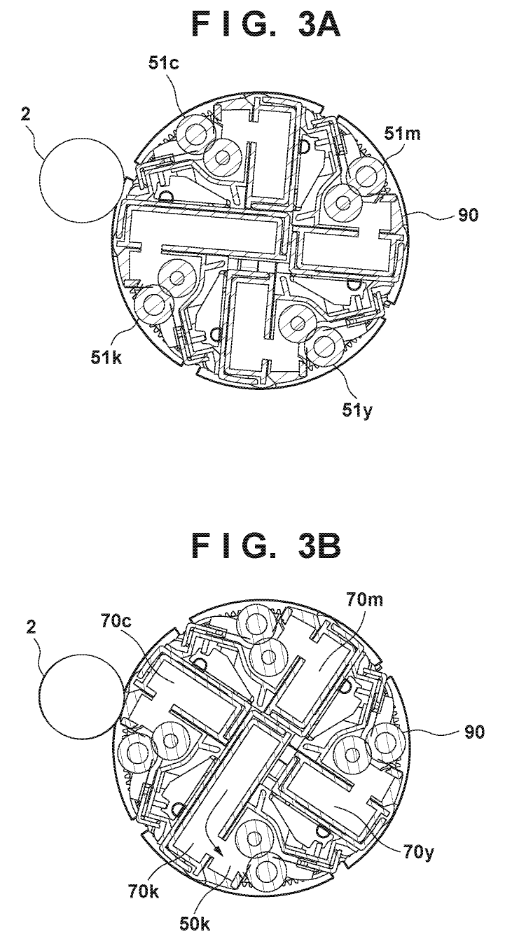

FIG. 3A illustrates an example of the standby posture (standby position). By rotating the rotary main body 90 about the rotation axis 90C, all of the developing rollers 51y, 51m, 51c, 51k can be put in a standby posture not facing the photosensitive drum 2. The standby posture is a posture where the photosensitive drum 2 is positioned between the developing roller 51c and the developing roller 51k. In the standby posture, the developing rollers 51 and the photosensitive drum 2 are separated. The rotary main body 90 is maintained in the standby posture while standing by for execution of image formation.

### 1-2-4. Replenishment Posture

FIG. 3B illustrates the replenishment posture (black replenishment posture) of the rotary main body 90. In this example, the black toner contained in the toner cartridge 70k is pulled by gravity and falls, with the black toner replenishing the developing unit 50k from the toner cartridge 70k. In other words, when the rotary main body 90 rotates, the developing units 50 and the toner cartridges 70 pass through a predetermined rotation area. Accordingly, the containers of the developing units 50 are replenished with toner from the containers of the toner cartridges 70. The predetermined rotation area includes a replenishment position illustrated in FIG. 3B.

When the rotary main body 90 rotates approximately 90 degrees in the clockwise direction, the yellow toner cartridge 70y is arranged at the replenishment position (yellow replenishment posture). When the rotary main body 90 further rotates approximately 90 degrees in the clockwise direction, the magenta toner cartridge 70m is arranged at the replenishment position (magenta replenishment posture). When the rotary main body 90 further rotates approximately 90 degrees in the clockwise direction, the cyan toner cartridge 70c is arranged at the replenishment position (cyan replenishment posture). Thus, when the rotary main body 90 performs a full rotation, the developing units 50y, 50m, 50c, 50k are each replenished with toner.

### 1-3. Specifics of Toner Cartridge and Developing Unit

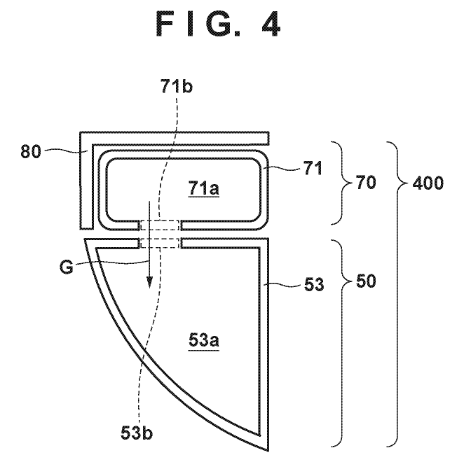

As illustrated in FIG. 4, a developing assembly 400 includes the developing unit 50 and the toner cartridge 70. The toner cartridge 70 includes a toner frame body 71. The toner frame body 71 includes a toner container 71a that contains toner and a discharge opening 71b connected to the toner container 71a.

The developing unit 50 includes a developing frame body (containing frame body) 53. The developing frame body 53 includes a toner supply chamber 53a and a receiving opening 53b connected to the toner supply chamber 53a. The toner supply chamber 53a is a container that contains toner supplied from the toner cartridge 70. The developing unit 50 includes the developing roller 51 and a supplying roller 52. To facilitate description, these members are omitted from FIG. 4.

The toner cartridge 70 can slide between an installed position (supply-ready position) and a retracted position (replacement position) relative to the developing frame body 53. In a case where the toner cartridge 70 is at the installed position, the discharge opening 71b faces the receiving opening 53b. In other words, the toner container 71a of the toner cartridge 70 and the toner supply chamber 53a of the developing unit 50 are in communication with each other via the discharge opening 71b and the receiving opening 53b. When the rotary main body 90 is rotated, at least a portion of the receiving opening 53b is positioned underneath (-Z side) at least a portion of the discharge opening 71b. At this time, the developing unit 50 is replenished with toner from the toner cartridge 70 via the discharge opening 71b and the receiving opening 53b.

As illustrated in FIG. 4, the replenishment posture includes all postures in a case where the direction from the discharge opening 71b, a first opening, toward the receiving opening 53b, a second opening, includes a downward component G in the vertical direction. In this manner, a force applied to the toner contained in the toner cartridge 70 is a vector and is a combination of two or more components. The two or more components should include a component oriented in the vertical direction. An operation in which the rotary main body 90 is in the replenishment posture and the developing unit 50 is replenished with toner from the toner cartridge 70 may be referred to as a replenishment operation or a replenishment mode. A replenishment posture for each of the four toner colors exists. For example, FIG. 3B illustrates the black replenishment posture. Since the black discharge opening 71b is positioned underneath the toner cartridge 70k, the black toner is efficiently pushed by gravity to the developing unit 50k. In other words, the toner contained in the toner container 71a is discharged from the discharge opening 71b, and the toner discharged from the discharge opening 71b flows through the receiving opening 53b and is contained in the toner supply chamber 53a. The toner contained in the toner supply chamber 53a is supplied to the developing roller 51. Via such a supply path, the toner contained in the toner container 71a is supplied to the developing roller 51.

### 1-4. Controller

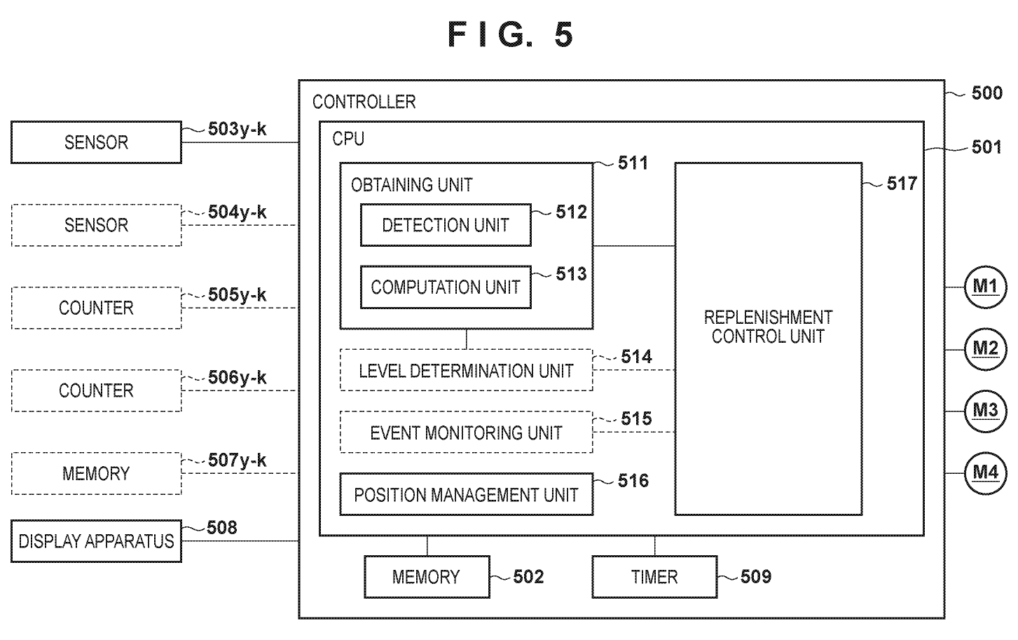

FIG. 5 illustrates a controller of the image forming apparatus 1 that executes image-forming operations. A CPU 501 is a processor that controls the image forming apparatus 1 by executing a control program stored in a ROM area of a memory 502. The CPU 501 may include one or more processors or one or more processor cores. ROM is an abbreviation for read-only memory. The memory 502 includes a random-access memory (RAM) area that functions as a work area. Note that the memory 502 is not limited to a semiconductor storage element and may include a hard disk drive (HDD) or the like.

A controller 500 controls motors M1, M2, M3, M4, for example. The motor M1 is a drive source that rotationally drives the rotary main body 90 about the rotation axis 90C. The motor M2 slides, from among the trays 80y, 80m, 80c, 80k, the tray 80 positioned at the replacement position via a driving force transmission apparatus (for example, gears, a shaft, a belt). The motor M3 drives the members other than the members driven by the motor M1 and the motor M2. For example, the motor M3 drives photosensitive drum 2; the developing units 50y, 50m, 50c, 50k; the pickup roller 36; the feed roller 38; the conveyance roller pair 39; the secondary transfer roller 12; the driving roller 10b; and the fixing apparatus 40. The motor M4 rotationally drives the swing shaft 91. Note that the members driven by the motors M1, M2, M3, M4 can be changed as appropriate. Any two or more motors from among the motors M1, M2, M3, M4 may be grouped together as one motor. On the other hand, a motor or a drive source (for example, a solenoid) other than the motors M1, M2, M3, M4 may be added.

The CPU 501 implements the plurality of functions described below by executing a control program. One or more or all of the plurality of functions may be implemented by another hardware circuit (for example, ASIC or FPGA). ASIC is an abbreviation for an application-specific integrated circuit. FPGA is an abbreviation for a field-programmable gate array.

An obtaining unit 511 obtains a remaining toner amount Ta contained in each of the developing units 50y, 50m, 50c, 50k and a remaining toner amount Tb contained in each of the toner cartridges 70y, 70m, 70c, 70k. The obtaining unit 511 includes a detection unit 512 and a computation unit 513. The detection unit 512 detects the remaining toner amount Ta of the developing units 50y, 50m, 50c, 50k using sensors 503y, 503m, 503c, 503k. The sensors 503y, 503m, 503c, 503k, for example, each include a light-emitting element that emits light towards a window provided in each of two facing wall surfaces of the developing units 50y, 50m, 50c, 50k and a light-receiving element that receives light via the windows. One window is referred to as a light incidence window and the other window is referred to as a light emission window. The detection unit 512 detects the remaining toner amount Ta of toner based on the intensity of the light received by the light-receiving element. Here, the windows are arranged in accordance with a predetermined amount T1 used as a threshold for the remaining toner amount Ta. In a case where the remaining toner amount Ta is greater than the predetermined amount T1, the light from the light-emitting element travelling toward the light-receiving element is blocked by the toner. In a case where the remaining toner amount Ta is less than the predetermined amount T1, the light from the light-emitting element travelling toward the light-receiving element is not blocked by the toner. Thus, the detection unit 512 can detect whether the remaining toner amount Ta is greater or not greater than the predetermined amount T1. Note that a window, a light-emitting element, and a light-receiving element may be arranged at a position corresponding to a predetermined amount T2 which is more than the predetermined amount T1. In this case, the detection unit 512 can also detect whether the remaining toner amount Ta is greater or not greater than the predetermined amount T2.

In this manner, the CPU 501 detects or determines whether the remaining toner amount Ta is greater than the predetermined amount T1. The CPU 501 also detects or determines whether the remaining toner amount Ta is greater than the predetermined amount T2. However, this is merely an example. The replenishment operation may be changed in accordance with the remaining toner amount Ta. For example, in a case where the remaining toner amount Ta is greater than the predetermined amount T2, a predetermined replenishment operation is executed. In a case where the remaining toner amount Ta is less than or equal to the predetermined amount T2 but greater than the predetermined amount T1, a different predetermined replenishment operation is executed. In a similar manner, when the remaining toner amount Ta is less than or equal to the predetermined amount T1, yet another different predetermined replenishment operation is executed.

The detection unit 512 detects the remaining toner amount Tb of the toner cartridges 70y, 70m, 70c, 70k using sensors 504y, 504m, 504c, 504k. The sensors 504y, 504m, 504c, 504k include, for example, a light-emitting element that emits light at the window provided on each of two facing wall surfaces of the toner cartridges 70y, 70m, 70c, 70k and a light-receiving element that receives light via the windows. The detection unit 512 detects the remaining toner amount Tb of toner based on the intensity of the light received by the light-receiving element. Here, the window is provided in accordance with a predetermined amount T3 used as a threshold for the remaining toner amount Tb. In a case where the remaining toner amount Tb is greater than the predetermined amount T3, the light from the light-emitting element travelling toward the light-receiving element is blocked by the toner. In a case where the remaining toner amount Tb is less than the predetermined amount T3, the light from the light-emitting element travelling toward the light-receiving element is not blocked by the toner. Thus, the detection unit 512 can detect whether the remaining toner amount Tb is greater or not greater than the predetermined amount T3. Note that a window, a light-emitting element, and a light-receiving element may be arranged at a position corresponding to a predetermined amount T4 which is more than the predetermined amount T3. In this case, the detection unit 512 can also detect whether the remaining toner amount Tb is greater or not greater than the predetermined amount T4.

In this manner, the CPU 501 detects or determines whether or not the remaining toner amount Tb is greater than the predetermined amount T3. The CPU 501 also detects or determines whether the remaining toner amount Tb is greater than the predetermined amount T4. However, this is merely an example. The replenishment operation may be changed in accordance with the remaining toner amount Tb. For example, in a case where the remaining toner amount Tb is greater than the predetermined amount T4, a predetermined replenishment operation is executed. In a case where the remaining toner amount Tb is less than or equal to the predetermined amount T4 but greater than the predetermined amount T3, a different predetermined replenishment operation is executed. In a similar manner, when the remaining toner amount Tb is less than or equal to the predetermined amount T3, yet another different predetermined replenishment operation is executed.

The computation unit 513 computes the remaining toner amount Ta for the developing units 50y, 50m, 50c, 50k using counters 505y, 505m, 505c, 505k. The counters 505y, 505m, 505c, 505k count the toner consumption amounts obtained by analyzing the image data that is the basis of images. The counters 505y, 505m, 505c, 505k accumulate the consumption amounts. The memory 502 or a memory 507k, 507m, 507c, 507k stores the initial value (toner amount when full) of the remaining toner amount Ta of the developing units 50y, 50m, 50c, 50k. The memories 507k, 507m, 507c, 507k are memories held in the toner cartridges 70y, 70m, 70c, 70k. The computation unit 513 subtracts the toner consumption amount indicated by the counters 505y, 505m, 505c, 505k from the initial values, respectively. In this manner, the remaining toner amount Ta of the developing units 50y, 50m, 50c, and 50k is obtained.

The computation unit 513 computes the remaining toner amount Tb of the toner cartridges 70y, 70m, 70c, 70k using counters 506y, 506m, 506c, 506k. The counters 506y, 506m, 506c, 506k count the toner consumption amounts obtained by analyzing the image data that is the basis of images. The counters 506y, 506m, 506c, 506k accumulate the consumption amounts. The memory 502 or a memory 507k, 507m, 507c, 507k store the initial value (toner amount when full) of the remaining toner amount Tb of the toner cartridges 70y, 70m, 70c, 70k. The computation unit 513 subtracts the toner consumption amount indicated by the counters 506y, 506m, 506c, 506k from the initial values, respectively. In this manner, the remaining toner amount Tb of the toner cartridges 70y, 70m, 70c, and 70k is obtained.

The counters 505, 506 count the toner consumption amount, but they may be configured to count the remaining toner amounts Ta, Tb. In this case, each time toner is consumed from the initial value, the counters 505, 506 subtract the consumption amount from the remaining toner amount.

The counter 505 counts the remaining toner amount Ta of the developing unit 50. In a case where the remaining toner amount Tb of the toner cartridge 70 is sufficiently high, each time the replenishment operation is executed, the counter 505 is reset to the initial value. The counter 506 is reset to the initial value each time the toner cartridge 70 is replaced with a new product.

In a first embodiment example, the sensor 503 is used, and the sensor 504 and the counters 505, 506 are optional. In other words the counter 505 may be used instead of the sensor 503. In a second embodiment example, the sensor 503 and the counter 506 are used. In this case, the sensor 504 may be used instead of the counter 506. Also, the counter 505 may be used instead of the sensor 503.

A level determination unit 514 determines the replenishment level using at least one remaining toner amount from among the remaining toner amount Ta of the developing unit 50 and the remaining toner amount Tb of the toner cartridge 70. For example, the replenishment level is determined in such a manner that the replenishment amount of toner from the toner cartridge 70 to the developing unit 50 is higher when the remaining toner amount Ta is lower. A further enhanced replenishment operation is executed in order to increase the toner replenishment amount. For example, a replenishment operation with a Lv 2 replenishment level is enhanced more than a replenishment operation with a Lv 1 replenishment level. A replenishment operation with a Lv 3 replenishment level is enhanced more than a replenishment operation with a Lv 2 replenishment level. In other words, a replenishment operation with a Lv i+1 replenishment level is enhanced more than a replenishment operation with a Lv i replenishment level. i is a positive integer of 1 or more. By enhancing the replenishment operation, the amount of time the replenishment posture is maintained is increased or the reliability of toner replenishment is increased.

An event monitoring unit 515 monitors the occurrence of events that trigger replenishment. An event is, for example, image formation ending, an error event such as one that suspends image formation (for example, a jam of the sheet S), and the like.

A position management unit 516 detects and manages the rotational position (rotational phase) of the rotary main body 90. For example, an encoder is attached to the rotation axis 90C of the rotary main body 90. The position management unit 516 identifies the rotational position of the rotary main body 90 based on a position signal output from the encoder. The position management unit 516 may detect the home position of the rotary main body 90 using a home position sensor that detects a notch or magnet provided at a specific position in the circumferential surface of the rotary main body 90. In this case, the position management unit 516 counts the number of drive pulses supplied to the motor M1 using a counter that is reset each time the home position is detected. The position management unit 516 may identify the rotational position of the rotary main body 90 based on a count value of the counter. Note that the counter of the position management unit 516 is reset each time the rotary main body 90 rotates one full rotation (360 degrees). In this manner, the count value of the counter indicates the absolute rotational position at all times.

A replenishment control unit 517 executes a replenishment operation to replenish the developing unit 50 with toner of a replenishment amount in accordance with the remaining toner amount (or the replenishment level). If under the same remaining toner amount condition, the amount of toner replenished changes depending on the replenishment level. For example, if under the same remaining toner amount condition, the amount of toner replenished by a replenishment operation with a Lv 2 replenishment level is more than the amount of toner replenished by a replenishment operation with a Lv 1 replenishment level. If under the same remaining toner amount condition, the amount of toner replenished by a replenishment operation with a Lv 3 replenishment level is more than the amount of toner replenished by a replenishment operation with a Lv 2 replenishment level. The replenishment control unit 517 may repeatedly execute a replenishment operation a number of times in accordance with the remaining toner amount (or the replenishment level). The replenishment control unit 517 may rotate the rotary main body 90 a number of times in accordance with the remaining toner amount (or the replenishment level). In other words, the number of rotations changes (is adjusted, selected, or determined) depending on the remaining toner amount. The replenishment control unit 517 may rotate the rotary main body 90 at a rotational speed in accordance with the remaining toner amount (or the replenishment level). For example, the replenishment control unit 517 may temporarily decrease the rotational speed for when the developing unit 50 to be replenished is in the replenishment posture (replenishment position) to less than the normal rotational speed. The rotational speed decreased amount may be determined in accordance with the remaining toner amount. By increasing the rotational speed decreased amount, the amount of time the replenishment posture is maintained may be increased. The replenishment control unit 517 may stop the rotary main body 90 for a predetermined stopping period when the developing unit 50 to be replenished is in the replenishment posture. The stopping period is a period in which the rotation of the rotary main body 90 is in a stopped state. The replenishment control unit 517 may increase the stopping period when the remaining toner amount is low. The replenishment control unit 517 may measure the stopping period using a timer 509, and when the stopping period ends, may resume the rotation of the rotary main body 90. By stopping the rotary main body 90 over the predetermined stopping period, the replenishment posture is continued during the predetermined stopping period.

The replenishment control unit 517 determines the replenishment amount in accordance with the remaining toner amount by referencing a table (data) stored in the ROM area of the memory 502. In this case, the table is determined in advance by experiment or simulation and written into the ROM area.

Note that in a case where the same replenishment operation is executed, there is a tendency for the toner replenishment amount to be greater when the remaining toner amount Tb of the toner cartridge 70 is greater. Thus, as described below, the replenishment control unit 517 determines the number of times the replenishment operation is executed (for example, the number of rotations of the rotary main body 90) based on the remaining toner amount Tb.

When the remaining toner amount Tb of the toner cartridge 70 becomes a value close to zero, the CPU 501 displays a message on a display apparatus 508 prompting for the toner cartridge 70 to be replaced.

### 1-5. Predetermined Amount Example

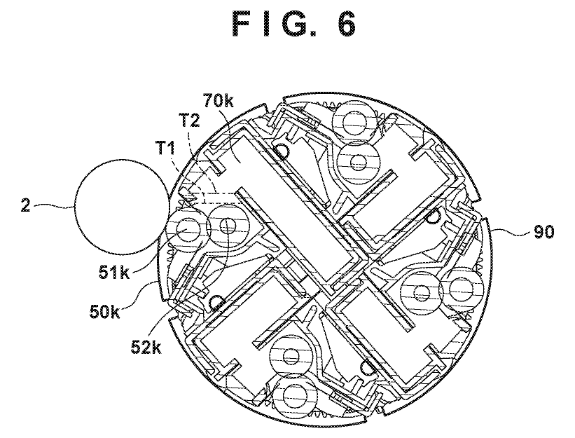

FIG. 6 is a diagram for describing the predetermined amounts T1, T2. The developing unit 50k is described in the example of FIG. 6 as a representative of the developing units 50y, 50m, 50c, 50k, and this is also the case for the predetermined amounts T1, T2 of the developing units 50y, 50m, 50c. In this example, since the rotary main body 90 is in the black development posture, the developing roller 51k of the developing unit 50k is in contact with the photosensitive drum 2. In other words, in the development posture, the developing roller 51k can be brought into contact with the photosensitive drum 2. The remaining toner amount Ta of the developing unit 50k is obtained when in the black development posture. Here, the predetermined amounts T1, T2 are determined in advance corresponding to the position of the upper surface (interface) of the toner contained in the developing unit 50k. In particular, the predetermined amount T1 is set to an amount that is slightly greater than a toner amount that would lead to insufficient toner supply and cause an image defect. When the supplying roller 52k is exposed from the toner interface, faintness occurs with a solid image. Thus, the predetermined amount T1 is the sum of the minimum toner amount and a margin that does not expose the supplying roller 52k from the toner interface. The margin is the toner amount required for forming a solid image on the entire surface of one sheet.

The predetermined amount T2 is set to an amount slightly less than essentially a toner maximum amount Tmax of the developing unit 50, for example. The toner maximum amount Tmax is a remaining toner amount that would make it hard for the developing unit 50 to be replenished with any more toner. As illustrated in FIG. 6, the predetermined amount T2 is defined as the remaining toner amount that makes the position of the lower end of the receiving opening 53b in the development posture the toner interface. When the upper surface of the toner is at a position that is higher than the position of the lower end of the receiving opening 53b in the development posture, the toner replenishment path may become narrow. This may also cause backflow of toner from the developing unit 50 to the toner cartridge 70. Thus, the toner replenishment amount may significantly decrease. The predetermined amount T2 is determined by subtracting a margin from the remaining toner amount at which the toner interface exists at the position of the lower end of the receiving opening 53b in the development posture. Here, the margin is the minimum amount of toner supplied from the toner cartridge 70 to the developing unit 50 when the rotary main body 90 performs one rotation.

### 1-6. Replenishment Level Example

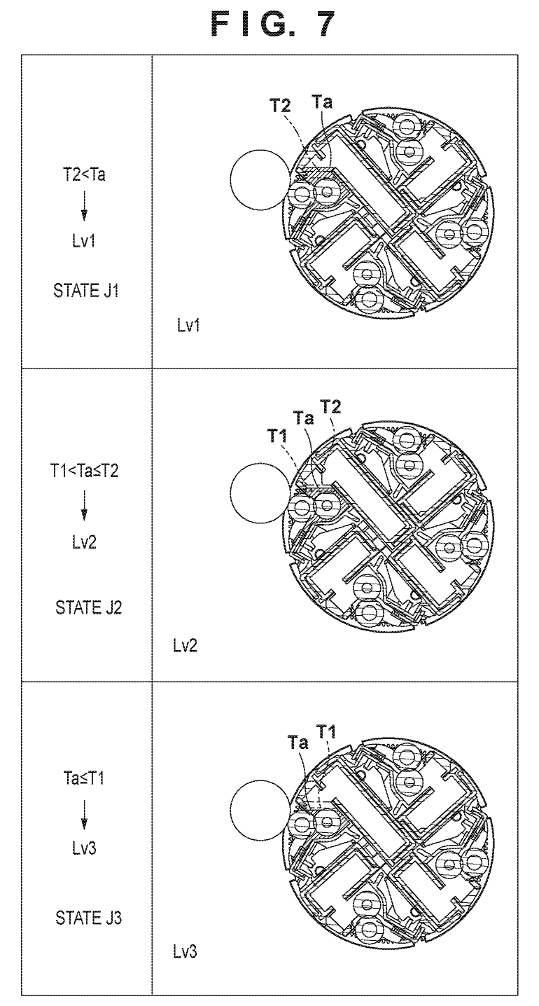

FIG. 7 is a diagram for describing a method for determining the replenishment level. In this example, the replenishment level is determined in such a manner that the amount of time that the replenishment posture is maintained is longer when the remaining toner amount Ta of the developing unit 50 is lower. In other words, the replenishment operation is enhanced when the remaining toner amount Ta of the developing unit 50 is lower. In a case where the remaining toner amount Ta is greater than the predetermined amount T2 (state J1), the replenishment level is determined as Lv 1. In a case where the remaining toner amount Ta is less than or equal to the predetermined amount T2 and the remaining toner amount Ta is greater than the predetermined amount T1 (state J2), the replenishment level is determined as Lv 2. In a case where the remaining toner amount Ta is less than or equal to the predetermined amount T1 (state J3), the replenishment level is determined as Lv 3. The replenishment amount of the replenishment level Lv 3 is greater than the replenishment amount of the replenishment level Lv 2. The replenishment amount of the replenishment level Lv 2 is greater than the replenishment amount of the replenishment level Lv 1. In this manner, since the amount of time the replenishment posture is maintained is longer when the remaining toner amount Ta is lower, it is less likely that the developing unit 50 will have insufficient toner. It is also less likely that an image defect is formed on the sheet S.

In this manner, the replenishment level changes depending on one or both of the state of the toner supply chamber 53a and the state of the toner cartridge 70. As illustrated in FIG. 7, the state J1 (or the state J2) of the toner supply chamber 53a in a case where the remaining toner amount Ta is greater than a first threshold is a first state. The state J2 (or the state J3) of the toner supply chamber 53a when the remaining toner amount Ta is less than the first threshold (for example, T2) is a second state. Note that the state J2 of the toner supply chamber 53a when the remaining toner amount Ta is less than the first threshold and greater than a second threshold may be the second state. The state J3 of the toner supply chamber 53a when the remaining toner amount Ta is less than the second threshold is a third state.

The amount of time the rotary main body 90 is in the replenishment posture in the replenishment mode which is executed when the toner supply chamber 53a is in the first state is set to a first amount of time. The amount of time the rotary main body 90 is in the replenishment posture in the replenishment mode which is executed when the toner supply chamber 53a is in the second state is set to a second amount of time. The second amount of time is longer than the first amount of time. The amount of time the rotary main body 90 is in the replenishment posture in the replenishment mode which is executed when the toner supply chamber 53a is in the third state is a third amount of time. The third amount of time is longer than the second amount of time.

### 1-7. Flowchart

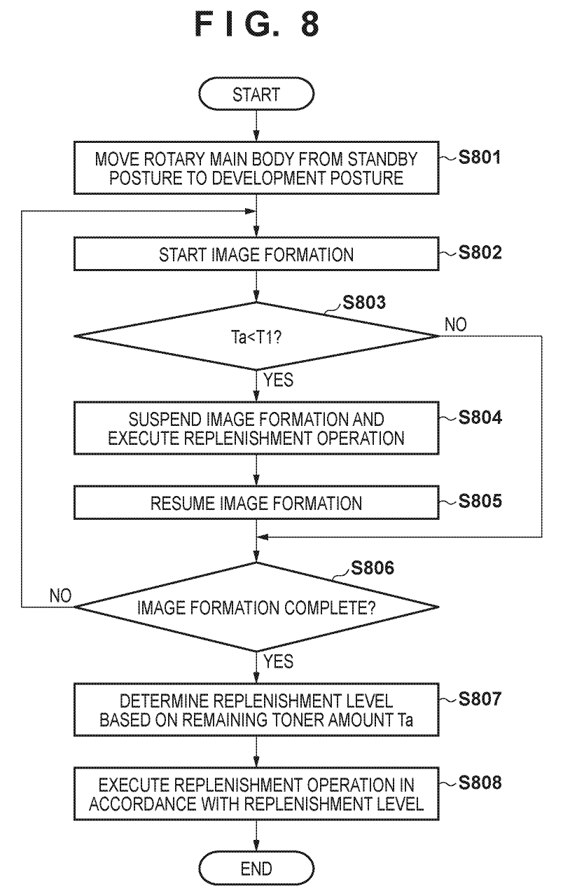

FIG. 8 illustrates a control method executed by the CPU 501 in accordance with a control program. Here, it is assumed that the print job is a monochrome print job for forming an image using only black ton. Also, the remaining toner amount of the developing unit 50k is taken into account, but the remaining toner amount Tb of the toner cartridge 70k is not taken into account.

In S801, the CPU 501 moves the rotary main body 90 from the standby posture to the black development posture. For example, the CPU 501 controls the motor M1 to rotate the rotary main body 90. The motor M1 is supplied with a predetermined number of drive pulses from the controller 500. Here, the predetermined number is the pulse number needed for moving the rotary main body 90 from the standby posture to the black development posture.

In S802, the CPU 501 starts image formation. In other words, the CPU 501 controls the image forming apparatus 1 based on the image data and forms a monochrome image on the sheet S.

In S803, the CPU 501 determines whether or not the remaining toner amount Ta of the developing unit 50k has become less than or equal to the predetermined amount T1 based on the detection result of the sensor 503k. The remaining toner amount Ta is obtained when the rotary main body 90 is in the black development posture. Note that the timing of obtaining the remaining toner amount Ta does not need to be when the rotary main body 90 is in a development posture. The remaining toner amount Ta may be obtained when the rotary main body 90 is in any posture between after a replenishment posture is passed and before a development posture. The sensor 503k that obtains the remaining toner amount Ta detects the remaining toner amount Ta as an analog amount. Alternatively, when the remaining toner amount Ta becomes less than or equal to the predetermined amount T1, the sensor 503k outputs “00”. When the remaining toner amount Ta becomes greater than the predetermined amount T1 and less than or equal to the predetermined amount T2, the sensor 503k outputs “01”. When the remaining toner amount Ta becomes greater than the predetermined amount T2, the sensor 503k outputs “10” or “11”. If the remaining toner amount Ta is not less than or equal to the predetermined amount T1, the CPU 501 advances from S803 to S805. If the remaining toner amount Ta is less than the predetermined amount T1, the CPU 501 advances from S803 to S804.

In S804, the CPU 501 suspends image formation in the image forming apparatus 1 and executes the replenishment operation. The CPU 501 suspends image formation by causing the motor M3 to stop. At this time, the CPU 501 controls the motor M4 to separate the rotary main body 90 from the photosensitive drum 2. Also, the replenishment control unit 517 replenishes the developing unit 50k with toner from the toner cartridge 70k by performing N rotations of the rotary main body 90. N is a natural number. N is 1, for example. In other words, the replenishment level of the replenishment operation executed during the suspension is Lv 1. Accordingly, the suspension time is reduced. Here, the replenishment level is fixed as Lv 1, but this is merely an example. For example, the replenishment level may be fixed as Lv 2 or Lv 3. Also, the CPU 501 may dynamically determine the replenishment level in accordance with the remaining toner amount Ta.

In S805, the CPU 501 resumes image formation in the image forming apparatus 1. The CPU 501 controls the motor M4 to bring the rotary main body 90 into contact with the photosensitive drum 2. The CPU 501 also reactivates the motor M3 and resumes rotation of the photosensitive drum 2 and the like.

In S806, the CPU 501 determines whether or not image formation is complete. For example, with a print job for forming an image on a predetermined number (for example, M number) of the sheets S, when an image has been formed on all M sheets S, the CPU 501 determines that image formation is complete. In this case, the CPU 501 advances from S806 to S807. In a case where an image has not been formed on all of the sheets S, the CPU 501 returns from S806 to S802 and starts image formation on the next sheet S.

In S807, the CPU 501 determines the replenishment level based on the remaining toner amount Ta obtained by the sensor 503k. In other words, the CPU 501 determines the replenishment level in accordance with the remaining toner amount state of the developing unit 50. As illustrated in FIG. 7, the level determination unit 514 determines the replenishment level by comparing the remaining toner amount Ta and the predetermined amounts T1, T2. Note that a mathematical formula, a table, or a program module for converting the remaining toner amount Ta to the replenishment level Lv may be used.

In S808, the CPU 501 executes the replenishment operation in accordance with the determined replenishment level Lv. The replenishment level Lv 1 is a level in which the rotary main body 90 is rotated once. Accordingly, the rotary main body 90 transitions to the standby posture after being in the replenishment posture once. The replenishment level Lv 2 is a replenishment level in which the rotary main body 90 is rotated twice. In this case, the rotary main body 90 transitions to the standby posture after being in the replenishment posture twice. The replenishment level Lv 3 is a replenishment level in which the rotary main body 90 is rotated three times. In this case, the rotary main body 90 transitions to the standby posture after being in the replenishment posture three times. In other words, the amount that the rotary main body 90 is rotated is greater when the replenishment level is higher. Note that the amount of time that the rotary main body 90 is maintained in the replenishment posture may be increased when the replenishment level is higher.

In the first embodiment example, the lower the remaining toner amount Ta of the developing unit 50, the greater the replenishment effect (replenishment performance) of the replenishment operation executed. Accordingly, the remaining toner amount Ta of the developing unit 50 is less likely to be insufficient. Thus, even if a monochrome print job of the same color is executed again, it is less likely that the toner of the developing unit 50 is insufficient. For example, even if image formation is successively executed using black toner, image formation is less likely to be suspended or it is possible to delay the suspension timing. When the remaining toner amount Ta of the developing unit 50 is greater, a lower replenishment level Lv is selected. In other words, when the remaining toner amount Ta of the developing unit 50 is great, the replenishment amount is reduced. That is, the execution time for the replenishment operation after the completion of image formation is reduced.

However, in some cases, the image forming apparatus may perform a first image-forming operation based on a first job and a second image-forming operation based on a second job received next after the first job. In this case, the replenishment operation is executed at least at one timing from among after the first image-forming operation, after the second image-forming operation, before the first image-forming operation, and before the second image-forming operation. A preparation operation after the image-forming operation is referred to as post-rotation. A preparation operation before the image-forming operation is referred to as pre-rotation. In other words, the replenishment operation is executed at either post-rotation or pre-rotation.

### 2. Second Embodiment Example

In the first embodiment example, the replenishment amount of the toner is adjusted in accordance with the remaining toner amount Ta of the developing unit 50. However, this is merely an example, and instead of the remaining toner amount Ta of the developing unit 50, the remaining toner amount Tb of the toner cartridge 70 may be taken into account. Also, both the remaining toner amount Ta and the remaining toner amount Tb may be taken into account. Regarding this, in the second embodiment example, a control method that takes into account both the remaining toner amount Ta and the remaining toner amount Tb will be described. Portions that are shared between the second embodiment example and the first embodiment example that have been described above will not be described in the second embodiment example.

### 2-1. Flowchart

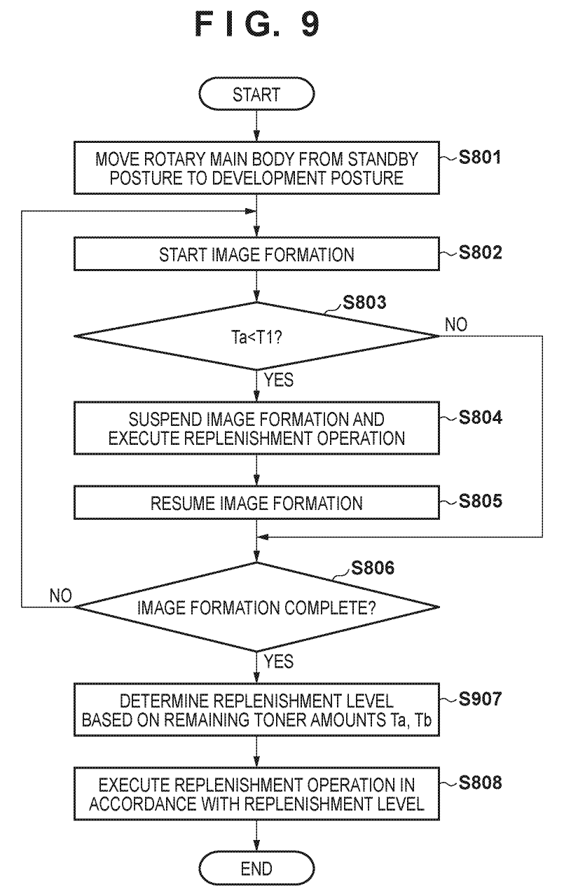

FIG. 9 is a flowchart illustrating a control method according to the second embodiment example. In FIG. 9, S807 illustrated in FIG. 8 is substituted with S907. In S907, the CPU 501 (level determination unit 514) determines the replenishment level Lv based on the remaining toner amounts Ta, Tb of the developing unit 50. The level determination unit 514 uses a mathematical formula, table, or program module with the remaining toner amounts Ta, Tb as inputs and the replenishment level Lv as an output to determine the replenishment level Lv corresponding to the remaining toner amounts Ta, Tb. Note that in the first embodiment example described above, when advancing from S803 to S804, the replenishment level executed in S804 is Lv 1. Also, in the first embodiment example described above, this replenishment level may be determined in accordance with the remaining toner amount Ta. In the second embodiment example, the remaining toner amount Tb may also be taken into account. In this case, the replenishment level of the replenishment operation executed in S804 is determined based on the remaining toner amounts Ta, Tb as in S907.

### 2-2. Predetermined Amounts T3, T4

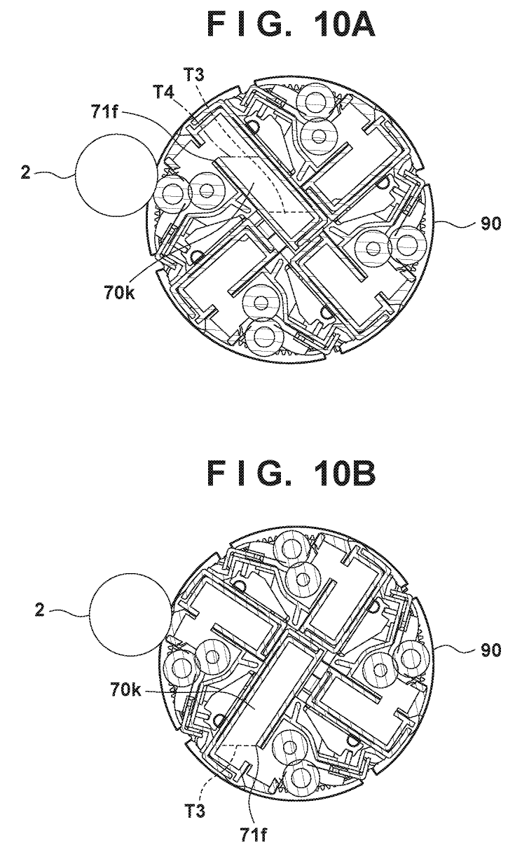

FIGS. 10A and 10B are diagrams for describing the predetermined amounts T3, T4 that are compared to the remaining toner amount Tb. Black toner is used in the example described here, but the same applies for the other colors. In FIG. 10A, the rotary main body 90 is in the black development posture. In FIG. 10B, the rotary main body 90 is in the black replenishment posture.

The predetermined amount T3 is the toner amount at which, when the remaining toner amount Tb of the toner cartridge 70 has decreased, the replenishment amount starts to be extremely low. As illustrated in FIG. 10B, the predetermined amount T3 is the toner amount that is contained in the toner cartridge 70 when the interface (upper surface) of the toner is at an end 71f of the discharge opening 71b in the replenishment posture. As illustrated in FIG. 10A, the position of the upper surface of the toner when the remaining toner amount Tb is the predetermined amount T3 in the development posture is indicated by the dashed line. When the remaining toner amount is less than the predetermined amount T3, the toner amount at or near the discharge opening 71b in the replenishment posture is low. In other words, the replenishment amount of toner from the toner cartridge 70 to the developing unit 50 in the replenishment operation is extremely low.

As illustrated in FIG. 10A, the predetermined amount T4 is greater than the predetermined amount T3. The predetermined amount T4 is the toner amount at which, when the remaining toner amount Tb of the toner cartridge 70 has increased, the replenishment amount starts to be extremely high. The dot-dash line indicates the predetermined amount T4. In other words, the predetermined amount T4 is the toner amount of when the interface of the toner is at the end 71f of the discharge opening 71b in the development posture. When the remaining toner amount Tb exceeds the predetermined amount T4, toner is easily supplied to the developing unit 50 even at the time of a transition from the replenishment posture to the development posture, and the replenishment amount for the toner cartridge 70 may be extremely high.

### 2-3. Replenishment Level Determination Method

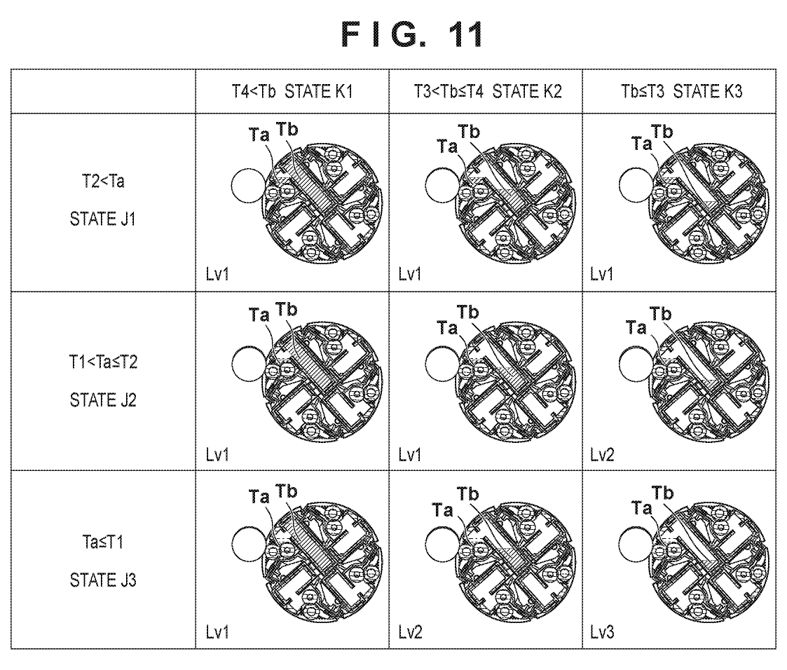

FIG. 11 is a diagram illustrating the relationship between the toner amounts Ta, Tb and the replenishment level Lv. Here, to make these relationships visually easy to understand, the remaining toner amount of the developing unit 50 in the development posture and the remaining toner amount of the toner cartridge 70 in the development posture are illustrated.

In FIG. 11, the states of the remaining toner amount of the developing unit 50 are classified into the states J1, J2, J3 described using FIG. 7. The states of the remaining toner amount of the toner cartridge 70 are classified into states K1, K2, K3. The state K1 is a state in which the remaining toner amount Tb is greater than the predetermined amount T4. The state K2 is a state in which the remaining toner amount Tb is less than or equal to the predetermined amount T4 but greater than the predetermined amount T3. The state K3 is a state in which the remaining toner amount Tb is less than or equal to the predetermined amount T3. The replenishment level is determined in accordance with a combination of the state of the remaining toner amount of the developing unit 50 and the state of the remaining toner amount of the toner cartridge 70 as illustrated in FIG. 11.

In a case where the remaining toner amount Ta is greater than the predetermined amount T2, regardless of the remaining toner amount Tb, the replenishment level Lv is determined as the first level Lv 1. In other words, in a case where the state of the remaining toner amount of the developing unit 50 is the state J1, even if the state of the remaining toner amount of the toner cartridge 70 is any of the states K1 to K3, the replenishment level is determined as Lv 1. In a case where the remaining toner amount Tb is greater than the predetermined amount T4, regardless of the remaining toner amount Ta, the replenishment level Lv is determined as the first level Lv 1. In other words, in a case where the state of the remaining toner amount of the toner cartridge 70 is the state K1, even if the state of the developing unit 50 is any one of the states J1 to J3, the replenishment level is determined as Lv 1.

In a case where the state of the remaining toner amount of the developing unit 50 is the state J2 and the state of the remaining toner amount of the toner cartridge 70 is the state K1 or K2, the replenishment level is determined as Lv 1. In a case where the state of the remaining toner amount of the developing unit 50 is the state J2 and the state of the remaining toner amount of the toner cartridge 70 is the state K3, the replenishment level is determined as Lv 2.

In a case where the state of the remaining toner amount of the developing unit 50 is the state J3 and the state of the remaining toner amount of the toner cartridge 70 is the state K1, the replenishment level is determined as Lv 1. In a case where the state of the remaining toner amount of the developing unit 50 is the state J3 and the state of the remaining toner amount of the toner cartridge 70 is the state K2, the replenishment level is determined as Lv 2. In a case where the state of the remaining toner amount of the developing unit 50 is the state J3 and the state of the remaining toner amount of the toner cartridge 70 is the state K3, the replenishment level is determined as Lv 3.

The replenishment level is selected in such a manner that when the remaining toner amount of the developing unit 50 is lower and the remaining toner amount of the toner cartridge 70 is lower, the replenishment amount of toner from the toner cartridge 70 to the developing unit 50 is higher. The replenishment level is selected in such a manner that when the remaining toner amount of the developing unit 50 is higher and the remaining toner amount of the toner cartridge 70 is higher, the replenishment amount of toner from the toner cartridge 70 to the developing unit 50 is lower.

In this manner, a state of the toner cartridge 70 corresponding to a case in which the remaining toner amount Tb of the toner cartridge 70 is greater than the third threshold (for example, T3 or T4) is the third state (for example, the state K2, K1). A state of the toner cartridge 70 corresponding to a case in which the remaining toner amount Tb of the toner cartridge 70 is less than the third threshold is the fourth state (for example, the state K3, K2).

The amount of time that the rotary main body 90 is in the replenishment posture in the replenishment mode executed in a case where the developing unit 50, which is a containing unit, is in the second state (for example, the state J2 or J3) and the toner cartridge 70 is in the third state is the third amount of time (Lv 1 or Lv 2). The amount of time that the rotary main body 90 is in the replenishment posture in the replenishment mode executed in a case where the developing unit 50 is in the second state and the toner cartridge 70 is in the fourth state is the fourth amount of time (Lv 2 or Lv 3). The fourth amount of time (for example, the replenishment level Lv 3, Lv 2) is longer than the third amount of time (for example, the replenishment level Lv 2, Lv 1).

Note that the fourth state may be the state K2 of the containing unit in a case where the remaining toner amount of the toner cartridge 70 is less than the third threshold (for example, T4) and greater than a fourth threshold (for example, T3) less than the third threshold. In this case, the state K3 of the toner cartridge 70 in a case where the remaining toner amount Tb of the toner cartridge 70 is less than the fourth threshold is a fifth state. The amount of time the rotary main body 90 is in the replenishment posture in the replenishment mode which is executed when the toner cartridge 70 is in the fifth state is a fifth amount of time. The CPU 501 executes the replenishment mode in such a manner that the fifth amount of time (for example, the replenishment level Lv 3, Lv 2) is longer than the fourth amount of time (for example, the replenishment level Lv 2, Lv 1).

In this manner, the replenishment level is determined at the timing at which the rotary main body 90 transitions from the development posture to the standby posture, and the replenishment operation is executed in accordance with the replenishment level. In particular, the lower the remaining toner amount Ta of the developing unit 50, the greater the replenishment effect of the replenishment operation executed. Accordingly, the remaining toner amount Ta of the developing unit 50 at the time of a transition to the standby posture is close to essentially the toner maximum amount. Thus, even if a plurality of images are again successively printed onto the sheets S via monochrome print jobs of the same color, image formation is less likely to be suspended. Also, the suspension timing can be delayed. In the second embodiment example, the replenishment level Lv is set to a lower replenishment level Lv compared to the first embodiment example in a case where the remaining toner amount Tb of the toner cartridge 70 is greater. Thus, the execution time for the replenishment operation after the end of image formation is further reduced.

The conditions illustrated in FIG. 11 may be changed. The size relationship A ≤ B may be substituted with the size relationship A < B. Conversely, the size relationship A < B may be substituted with the size relationship A ≤ B. “A certain value being greater than or equal to a threshold” may be substituted with “a certain value being greater than a threshold”. “A certain value being less than or equal to a threshold” may be substituted with “a certain value being less than a threshold”.

### 3. Modification Example

In the first embodiment example and the second embodiment example, the replenishment level Lv is determined at the timing at which the rotary main body 90 returns to the standby posture from the development posture after the end of image formation and the replenishment operation is executed. However, this is merely an example. For example, the event monitoring unit 515 may detect a different event that has no relationship with the remaining toner amounts Ta, Tb during a monochrome job. A different event may be, for example, an error event that suspends the print job such as the sheet S being jammed, the fixing apparatus 40 having an abnormally high temperature, and the like. In this case, the replenishment control unit 517 executes, as the replenishment operation, S807 or S907 and S808 during suspension of the print job causing the error event. In this manner, it is less likely that a subsequent monochrome job is suspended or the suspension timing can be delayed.

In the first embodiment example and the second embodiment example, it is assumed that only the toner cartridge 70 can be replaced and the developing unit 50 cannot be replaced. In a case where only the toner cartridge 70 can be replaced, directly after replacement of the toner cartridge 70, the remaining toner amount Ta of the developing unit 50 tends to be low and the remaining toner amount Tb of the toner cartridge 70 tends to be high. In other words, in a case where only the toner cartridge 70 can be replaced, there are many cases in which the effect of the present embodiment example is obtained. However, if the toner cartridge 70 and the developing unit 50 are integrally formed, the first embodiment example and the second embodiment example can be applied.

In the first embodiment example and the second embodiment example, when the replenishment level Lv is higher, the number of rotations of the rotary main body 90 increases, and thus the total value for the amount of time that the replenishment posture is maintained is increased. However, this is merely an example. For example, instead of the number of rotations of the rotary main body 90 or together with the number of rotations, the rotational speed in the replenishment posture may be adjusted. For example, when the replenishment level Lv is higher, the rotational speed in the replenishment posture may be lower. Alternatively, the replenishment control unit 517 may cause the rotary main body 90 to stop in the replenishment posture. In this case, the higher the replenishment level Lv, the more the stoppage time may be increased.

In the first embodiment example and the second embodiment example, the predetermined amounts T1, T2 of the developing unit 50 are provided, but only one of these predetermined amounts may be used. Furthermore, three or more predetermined amounts may be used. When n predetermined amounts are used, it is possible to determine n+1 number of replenishment levels. n is a natural number of 1 or more. This is the same for the predetermined amounts T3, T4 of the toner cartridge 70 of the second embodiment example. Only one of these predetermined amounts may be used. Furthermore, three or more predetermined amounts may be used.

In the first embodiment example and the second embodiment example, the remaining toner amounts Ta, Tb are detected by the sensor devices or computed by the CPU 501. Furthermore, for the predetermined amounts T1 to T4, the same method is used or different methods are used. A comparison result of the remaining toner amount Ta and the predetermined amount T1 is detected by the sensor 503. A comparison result of the remaining toner amount Ta and the predetermined amount T2 is detected using the counter 505. A comparison result of the remaining toner amount Tb and the predetermined amounts T3, T4 is detected using the counter 506. These are merely examples. A comparison result of the remaining toner amount Ta and the predetermined amount T1 may be computed using the counter 505. A comparison result of the remaining toner amount Ta and the predetermined amount T2 may be detected by the sensor 503. A comparison result of the remaining toner amount Tb and the predetermined amounts T3, T4 may be detected by the sensor 504. Note that, compared to methods using the counters 505, 506, methods using the sensors 503, 504 are advantageous in terms of detection accuracy. Compared to methods using the sensors 503, 504, methods using the counters 505, 506 are advantageous in terms of manufacturing costs.

In the first embodiment example and the second embodiment example, each of the remaining toner amounts Tby, Tbm, Tbc, Tbk of the toner cartridge 70 is stored in the memories 507y, 507m, 507c, 507k. However, this is merely an example. For example, the remaining toner amounts Tby, Tbm, Tbc, Tbk may be stored in the memory 502. In this case, when the toner cartridge 70 is replaced with a new product, the remaining toner amount Tb is reset. For example, the CPU 501 detects the toner cartridge 70 being replaced with a new product by monitoring the identification information (for example, a manufacture serial number) unique to the toner cartridge 70 stored in the memory 507. If the unique identification information read out last time and the unique identification information read out this time are different, it can be determined that a new product replacement has been performed.

In the embodiment examples described above, a monochrome print job has been described, but these can also be applied to a color print job. In this case, the replenishment operation is executed when the remaining toner amount Ta of toner of at least one color from among the four colors becomes less than the predetermined value T1 in S803. As a result, not only is the toner of the color with the remaining toner amount Ta that is less than the predetermined value T1 replenished, but the toner of the other colors is also replenished. This is because the rotary main body 90 is rotated at least once in the replenishment operation. In S807 and S907, the replenishment levels Lvy, Lvm, Lvc, Lvk are determined for the four colors. In S808, the replenishment operation is executed in accordance with the maximum replenishment level from among the replenishment levels Lvy, Lvm, Lvc, Lvk. The replenishment operation does not depend on the number of rotations but does depend on the stoppage time or the rotational speed in the replenishment posture. In this case, for each toner color, the stoppage time or the rotational speed is determined in accordance with the corresponding replenishment level Lv.

In the embodiment examples described above, the replenishment level Lv is defined in such a manner that the replenishment amount is greater when the replenishment level Lv is greater. However, this is merely an example. The replenishment level Lv may be defined in such a manner that the replenishment amount is greater when the replenishment level Lv is lower. In either case, it is sufficient that when the remaining toner amounts Ta, Tb are lower, a more enhanced replenishment operation is executed.

### 4. Notes

The developing assembly 400 is an example of a developing unit that includes a first container (for example, the toner cartridge 70) containing toner and a second container (for example, the developing unit 50) containing toner replenished from the first container. The rotary main body 90 is an example of a rotary body that rotates while holding the plurality of developing assemblies 400. The photosensitive drum 2 is an example of an image carrier disposed facing the rotary body that carries an image for development by toner supplied from one developing unit arranged at a development position from among the plurality of developing units. The motor M1 is an example of a drive unit that rotationally drives the rotary body in a manner such that one developing unit is arranged at the development position, each of the plurality of developing units are at a standby position not facing the image carrier, and the like. The controller 500 is an example of a control unit that controls the replenishment amount of the toner replenished from the first container to the second container in the developing unit that is the replenishment target in accordance with the remaining toner amount in the developing unit that is the replenishment target from among the plurality of developing units. In this manner, the toner replenishment operation is enhanced.

The controller 500 causes the rotary main body 90 to rotate via the motor M1 and the developing assembly 400 to pass through a predetermined rotation area (replenishment position). In this manner, toner drops from the toner cartridge 70 of the developing assembly 400 that is the replenishment target to the developing unit 50. As a result, the mechanism for executing the replenishment operation is simplified.

The CPU 501, the obtaining unit 511, the sensors 503, 504, and the counters 506, 507 are examples of an obtaining unit that obtains the remaining toner amounts Ta, Tb.

The amount of time that the replenishment posture is maintained is increased when the remaining toner amount Ta of the developing unit 50 is lower. Accordingly, image defects caused by insufficient toner are less likely to occur.

A toner replenishment operation in a case where the remaining toner amount Ta of the developing unit 50 is not greater than a threshold (for example, the predetermined value T1) is enhanced more than a toner replenishment operation in a case where the remaining toner amount Ta is greater than the threshold. The controller 500 causes the rotary main body 90 to rotate via the motor M1 to execute the replenishment operation. In this manner, by controlling the replenishment amount using a threshold, replenishment control is made easier.

As illustrated in FIG. 7, the toner replenishment operation in a case where the remaining toner amount Ta is not greater than the first threshold (for example, the predetermined value T1) is greater than the replenishment amount in a case where the remaining toner amount Ta is greater than the first threshold but not greater than the second threshold (for example, the predetermined value T2). The toner replenishment operation in a case where the remaining toner amount Ta is greater than the first threshold but not greater than the second threshold is greater than the toner replenishment operation in a case where the remaining toner amount Ta is greater than the second threshold. Accordingly, the remaining toner amount Ta of the developing unit 50 is maintained at an appropriate amount.

In the first embodiment example and the second embodiment example, the predetermined values T1, T2 are used as examples, but more thresholds may be used. For example, the toner replenishment operation in a case where the remaining toner amount Ta is greater than the first threshold but not greater than the second threshold is enhanced over the toner replenishment operation in a case where the remaining toner amount Ta is greater than the second threshold but not greater than the third threshold T5. The toner replenishment operation in a case where the remaining toner amount Ta is greater than the second threshold but not greater than the third threshold T5 is enhanced over the toner replenishment operation in a case where the remaining toner amount Ta is greater than the third threshold T5. In other words, when the remaining toner amount Ta is great, the replenishment amount is reduced. The amount of time that the replenishment posture is maintained is increased when the remaining toner amount Ta is lower.

In the first embodiment example and the second embodiment example, two thresholds (the predetermined values T1, T2) are used for the remaining toner amount Ta, but this is merely an example. One threshold, such as the predetermined value T1 or the predetermined value T2, may be used.

As described in the second embodiment example, the replenishment amount and the replenishment operation are determined using the remaining toner amount Tb of the toner cartridge 70, the first threshold, and the second threshold (for example, the predetermined values T3, T4). As suggested by FIG. 11, the replenishment operation in the case of T3 < Tb is enhanced over the replenishment operation in a case where T4 < Tb < T3. The replenishment operation in a case where T4 < Tb < T3 is enhanced over the replenishment operation in a case where T4 < Tb. In other words, the number of times the replenishment operation is executed is increased when the remaining toner amount Tb is lower. In this manner, the amount of time that the replenishment posture is maintained is increased. Note that the number of times the replenishment operation is executed may be reduced when the remaining toner amount Tb is greater.

A replenishment level determined based on the remaining toner amount is used. For example, the replenishment level is defined in such a manner that the amount of time that the replenishment posture is maintained is increased when the replenishment level is higher. The replenishment level is defined in such a manner that the replenishment operation is enhanced when the replenishment level is higher.

As illustrated in FIG. 7, in a case where the remaining toner amount Ta is not greater than the predetermined value T1 (or T2), the replenishment level Lv is set to Lv 3 (or Lv 2). In a case where the remaining toner amount Ta is not greater than the predetermined value T1 (or T2), the replenishment level Lv is set to Lv 2 (or Lv 1).

As illustrated in FIG. 7, in the case of Ta < T1, the replenishment level Lv is set to Lv 3. In the case of T1 < Ta < T2, the replenishment level Lv is set to Lv 2. In the case of T2 < Ta, the replenishment level Lv is set to Lv 1. In other words, a more enhanced replenishment operation is executed when the replenishment level Lv is higher. A more enhanced replenishment operation is executed when the remaining toner amount Ta is lower.

As illustrated in FIG. 11, in the case of Ta < T1 and Tb < T3, the replenishment level is set as Lv 3. In the case of Ta < T1 and T3 < Tb < T4, the replenishment level is set as Lv 2. In the case of T1 < Ta < T2 and Tb < T3, the replenishment level is set as Lv 2. In the case of T2 < Ta, the replenishment level is set to Lv 1. In the case of T4 < Tb, the replenishment level is set to Lv 1. Here, a replenishment operation with a Lv i+1 replenishment level is enhanced more than a replenishment operation with a Lv i replenishment level. i is a natural number. In this manner, by taking into account both the remaining toner amount Ta of the developing unit 50 and the remaining toner amount Tb of the toner cartridge 70, a more appropriate replenishment operation is executed. As a result, image defects are reduced or the execution time for the replenishment operation is reduced. Also, the number of times a forced replenishment operation is executed due to suspension of image formation is reduced.

As suggested by FIG. 11, in the case of T1 < Ta < T2 and T3 < Tb < T4, the replenishment level is set as Lv 1.

As illustrated in FIG. 4, the discharge opening 71b of the toner cartridge 70 is an example of a first opening of the first container. The receiving opening 53b is an example of a second opening of the second container. The toner cartridge 70 replenishes the developing unit 50 with toner via the discharge opening 71b and the receiving opening 53b.

As illustrated in FIG. 6 and the like, the obtaining unit 511 obtains the remaining toner amount Ta at a time when the developing rollers 51 of the developing assembly 400 that is the replenishment target is positioned at the development position. The rotary main body 90 can be rotated 360 degrees. Thus, the problem becomes what position should the developing unit 50 be in when measuring the remaining toner amount Ta. To suppress or avoid having insufficient remaining toner amount Ta of the developing unit 50 during development, the remaining toner amount Ta should be measured when the developing unit 50 is located at the development position.

As described in the first embodiment example, the sensor 503 and the detection unit 512 are an example of a detection unit that detects the remaining toner amount Ta via a window provided in the wall surface of the developing unit 50. In this case, the window is provided at least at one of a position corresponding to the predetermined amount T1 and a position corresponding to the predetermined amount T2.

The sensor 504 and the detection unit 512 detect the remaining toner amount Tb via a window provided in the wall surface of the toner cartridge 70. The window is provided at least at one of a position corresponding to the predetermined amount T3 and a position corresponding to the predetermined amount T4.

As described in relation to FIG. 5, the computation unit 513 is an example of a computation unit that obtains toner consumption amounts by analyzing the image data that is the basis of images, accumulates the toner consumption amounts, and computes the remaining toner amount based on the accumulated toner consumption amounts.

As described in relation to FIG. 5, the remaining toner amount Ta is detected by the sensor 503 and the detection unit 512. The remaining toner amount Tb is computed by the computation unit 513.

As illustrated in FIGS. 8 and 9, when image formation on M sheets S is complete, the replenishment operation is executed. In this manner, it is less likely that the replenishment operation is executed during image formation, and the user waiting time is reduced.

When an error event occurs, the replenishment operation is executed. In this manner, a resolution operation for the error event and the replenishment operation are executed in parallel with one another. As a result, the user waiting time is reduced.

An error event is a paper jam, for example. An error event is an event which causes image formation to be suspended.

The replenishment operation is executed by rotation of the rotary main body 90. Thus, the replenishment operation is enhanced when the number of rotations of the rotary main body 90 is increased.

The replenishment operation includes temporarily decreasing the rotational speed of the rotary main body 90 in a predetermined rotation area including the rotational phase (replenishment position) where toner replenishment is executed. The replenishment operation is enhanced by increasing the amount by which the rotational speed is decreased. Note that a combination of increasing the number of rotations and decreasing the rotational speed may be used.

The replenishment operation includes stopping the rotary main body 90 when the developing unit 50 is positioned at the replenishment position. The replenishment operation is enhanced by increasing the stoppage time. Note that a combination of increasing the number of rotations and increasing the stoppage time may be used. Note that a combination of temporarily decreasing the rotational speed and increasing the stoppage time may be used. Note that a combination of increasing the number of rotations, temporarily decreasing the rotational speed, and increasing the stoppage time may be used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-029371, filed February 26, 2025, which is hereby incorporated by reference herein in its entirety.

What is claimed is:

1. An image forming apparatus comprising:
a rotary to and from which a toner cartridge containing toner is attachable and detachable, the rotary including a developing roller and a containing unit that contains toner supplied from the toner cartridge; and
a processor configured to control rotation of the rotary,
wherein the rotary is switchable to a replenishment posture in which the containing unit is replenished with the toner from the toner cartridge,
the processor executes a replenishment mode in which the rotary is rotated to be in the replenishment posture,
a state of the containing unit in a case where a remaining toner amount of the containing unit is greater than a first threshold is a first state,
a state of the containing unit in a case where the remaining toner amount of the containing unit is less than the first threshold is a second state,
an amount of time that the rotary is in the replenishment posture in the replenishment mode executed in a case where the containing unit is in the first state is a first amount of time,
an amount of time that the rotary is in the replenishment posture in the replenishment mode executed in a case where the containing unit is in the second state is a second amount of time, and
the processor executes the replenishment mode in such a manner that the second amount of time is longer than the first amount of time.

2. The image forming apparatus according to claim 1, wherein
the second state is a state of the containing unit in a case where the remaining toner amount of the containing unit is less than the first threshold and greater than a second threshold less than the first threshold,
a state of the containing unit in a case where the remaining toner amount of the containing unit is less than the second threshold is a third state,
an amount of time that the rotary is in the replenishment posture in the replenishment mode executed in a case where the containing unit is in the third state is a third amount of time, and
the processor executes the replenishment mode in such a manner that the third amount of time is longer than the second amount of time.

3. The image forming apparatus according to claim 1, wherein
the toner cartridge includes a first opening,
the containing unit includes a second opening that is in communication with the first opening, and
when the rotary is in the replenishment posture, a direction from the first opening to the second opening includes a downward component in a vertical direction.

4. The image forming apparatus according to claim 1, wherein
an amount of time that the rotary is in the replenishment posture in the replenishment mode is determined based on the remaining toner amount of the containing unit and a remaining toner amount of the toner cartridge.

5. The image forming apparatus according to claim 4, wherein
a state of the toner cartridge in a case where the remaining toner amount of the toner cartridge is greater than a third threshold is a third state,
a state of the toner cartridge in a case where the remaining toner amount of the toner cartridge is less than the third threshold is a fourth state,
an amount of time that the rotary is in the replenishment posture in the replenishment mode executed in a case where the containing unit is in the second state and the toner cartridge is in the third state is a third amount of time,
an amount of time that the rotary is in the replenishment posture in the replenishment mode executed in a case where the containing unit is in the second state and the toner cartridge is in the fourth state is a fourth amount of time, and
the fourth amount of time is longer than the third amount of time.

6. The image forming apparatus according to claim 1, wherein
the processor increases an amount of time that the rotary is in the replenishment posture in the replenishment mode by increasing a number of rotations of the rotary.

7. The image forming apparatus according to claim 1, wherein
the processor increases an amount of time that the rotary is in the replenishment posture in the replenishment mode by increasing an amount of time that the rotary is stopped in the replenishment posture.

8. The image forming apparatus according to claim 1, wherein
the processor increases an amount of time that the rotary is in the replenishment posture in the replenishment mode by decreasing a rotational speed of the rotary in the replenishment posture.

9. The image forming apparatus according to claim 1, wherein
the image forming apparatus performs a first image-forming operation based on a first job and a second image-forming operation based on a second job received next after the first job, and
the replenishment mode is executed at least at one timing from among after the first image-forming operation, after the second image-forming operation, before the first image-forming operation, and before the second image-forming operation.

10. The image forming apparatus according to claim 2, wherein
the rotary is switchable to a development posture in which the developing roller can be brought into contact with an image carrier,
in a case where the rotary is in the development posture and the remaining toner amount of the containing unit is less than the second threshold, the processor suspends an image-forming operation and executes the replenishment mode, and
the processor resumes the image-forming operation after completion of the replenishment mode.

11. The image forming apparatus according to claim 5, wherein
the fourth state is a state of the toner cartridge in a case where the remaining toner amount of the toner cartridge is less than the third threshold and greater than a fourth threshold less than the third threshold,
a state of the toner cartridge in a case where the remaining toner amount of the toner cartridge is less than the fourth threshold is a fifth state,
an amount of time that the rotary is in the replenishment posture in the replenishment mode executed in a case where the toner cartridge is in the fifth state is a fifth amount of time, and
the processor executes the replenishment mode in such a manner that the fifth amount of time is longer than the fourth amount of time.

12. The image forming apparatus according to claim 10, wherein
the remaining toner amount of the containing unit and the remaining toner amount of the toner cartridge are obtained when the rotary is in the development posture.

13. The image forming apparatus according to claim 12, wherein
the processor obtains the remaining toner amount of the containing unit.

14. The image forming apparatus according to claim 12, wherein
the processor obtains the remaining toner amount of the toner cartridge.

15. The image forming apparatus according to claim 1, wherein
the processor accumulates toner consumption amounts by analyzing image data that is a basis of images formed on a printing medium by the image forming apparatus and computes the remaining toner amount based on a toner consumption amount obtained by the accumulation.
